(19) United States
(12) Patent Application Publication
(10) Pub. No.: US 2021/0245447 A1
(43) Pub. Date: Aug. 12, 2021

(54) MANUFACTURING METHOD OF HIGH-PRESSURE TANK

(71) Applicant: TOYOTA JIDOSHA KABUSHIKI KAISHA, Toyota-shi (JP)

(72) Inventor: Masayoshi TAKAMI, Hamamatsu-shi (JP)

(73) Assignee: TOYOTA JIDOSHA KABUSHIKI KAISHA, Toyota-shi (JP)

(21) Appl. No.: 17/159,650

(22) Filed: Jan. 27, 2021

(30) Foreign Application Priority Data
Feb. 10, 2020 (JP) 2020-020976

(51) Int. Cl. B29C 65/00; B29C 65/02

(52) U.S. Cl. CPC B29C 66/612; B29L 2031/7156; B29C 66/721; B29C 65/02

(57) ABSTRACT

In a manufacturing method of a high-pressure tank, a tubular member and dome members are prepared. The tubular member and the dome members are a plurality of divided bodies having a shape in which a reinforcement layer is divided and made of fiber reinforced resin so as to include contact surfaces that are in contact with an outer surface of a liner. Then, the contact surfaces are covered by resin layers constituting the liner. Next, the reinforcement layer and the liner are formed by joining the tubular member and the dome members to each other and joining the resin layers to each other.

### CROSS-REFERENCE TO RELATED APPLICATION

This application claims priority to Japanese Patent Application No. 2020-020976 filed on Feb. 10, 2020, incorporated herein by reference in its entirety.

### BACKGROUND

### 1. Technical Field

The disclosure relates to a manufacturing method of a high-pressure tank.

### 2. Description of Related Art

For example, a high-pressure tank for storing fuel gas is used in a natural gas vehicle and a fuel cell vehicle, etc. In this type of high-pressure tank, an outer surface of a liner containing the fuel gas is covered with a reinforcement layer that is made of a fiber reinforced resin.

For example, Japanese Unexamined Patent Application Publication No. 2019-132340 (JP 2019-132340 A) proposes a manufacturing method of such a high-pressure tank. In the manufacturing method, a plurality of resin parts having shapes into which the liner is divided are prepared, and the liner is formed by joining the parts by heat welding.

Further, the reinforcement layer is formed by winding a fiber bundle impregnated with resin around the liner formed as above.

### SUMMARY

However, in the method described in JP 2019-132340 A, rigidity of the resin parts is often low. Therefore, when the parts are joined to each other to form the liner, end portions of the parts are bent due to their own weight, and it takes time to align the parts with each other. Consequently, it is difficult to form the liner having a stable shape.

The disclosure provides a manufacturing method of a high-pressure tank by which a liner having a stable shape can be formed easily.

The manufacturing method of the high-pressure tank according to the disclosure provides a manufacturing method of a high-pressure tank in which a reinforcement layer made of fiber reinforced resin is provided on an outer surface of a liner that is made of resin and is configured to contain gas. The manufacturing method includes at least: forming a plurality of divided bodies made of the fiber reinforced resin and having a shape in which the reinforcement layer is divided so as to include contact surfaces in contact with the outer surface of the liner; covering the contact surfaces of the divided bodies with respective resin layers constituting the liner; and forming the reinforcement layer having the divided bodies and the liner having the resin layers by joining the divided bodies to each other and joining the resin layers covering the divided bodies to each other.

According to an aspect of the disclosure, the divided bodies are made of fiber reinforced resin, and the contact surfaces of the divided bodies are covered with the resin layers constituting the liner. With this configuration, when the resin layers covering the respective divided bodies are joined to each other, the resin layers constituting the liner are supported by the corresponding divided bodies. Therefore, the resin layers are less likely to be deformed by their own weight. Therefore, the alignment between the resin layers becomes easy. Consequently, the liner having a stable shape can be easily formed together with the reinforcement layer.

According to the aspect above, the divided bodies may be jointed to each other and the resin layers covering the divided bodies may be joined to each other by causing end surfaces of the divided bodies to abut each other together with the resin layers via a joining member.

According to the aspect above, the divided bodies are joined to each other via the joining member. Therefore, direct contact between the end surfaces of the divided bodies can be avoided. With this configuration, generation of powder dust caused by contact between the end surfaces of the divided bodies can be avoided. Further, the joining member is also disposed between the resin layers. Therefore, the joining member can serve as a sealing material. With this configuration, the airtightness against the high-pressure gas contained in the liner can be improved.

According to the aspect above, a tubular member and two dome members that are the divided bodies covered with the resin layers may be prepared and a through hole may be provided on at least one of the two dome members. The reinforcement layer and the liner may be formed by joining peripheral edge portions on respective ends of the tubular member to peripheral edge portions of the dome member, and joining the resin layer covering the tubular member to the resin layers covering the dome members. After the reinforcement layer and the liner are formed, seal layers may be formed on at least seams between the resin layer covering the tubular member and the resin layers covering the dome members by applying a resin material to the seams via the through hole such that at least the seams are covered by the seal layers.

The tubular member and the two dome members prepared as the divided bodies are made of fiber reinforced resin. When the resin layers covering the tubular member and the dome members are joined to each other, the resin layers constituting the liner are supported by the corresponding tubular member and the dome members. Therefore, the resin layers are less likely to be deformed by their own weight. Therefore, the alignment between the resin layers becomes easy. Consequently, the liner having a stable shape can be easily formed together with the reinforcement layer.

Further, the seal layers are formed on the seams between the resin layer covering the tubular member and the resin layers covering the dome members by applying the resin material to the seams through the through hole so as to cover the seams. Accordingly, the airtightness of the liner can be improved.

According to the manufacturing method of the disclosure, the liner having a stable shape can be easily formed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a structure of a high-pressure tank manufactured using a manufacturing method according to an embodiment of the disclosure;

FIG. 2 is a partial sectional view showing the structure of the high-pressure tank shown in FIG. 1;

FIG. 3 is a flowchart illustrating a procedure of the manufacturing method of the high-pressure tank according to the embodiment of the disclosure;

FIG. 4 is a partial sectional view for illustrating a forming method of dome members in a forming step shown in FIG. 3;

FIG. 5 is a sectional view of the dome members formed in the forming step shown in FIG. 3;

FIG. 6 is a sectional view for illustrating a forming method of a tubular member in the forming step shown in FIG. 3;

FIG. 7 is a sectional view of the dome members in which the dome members shown in FIG. 5 are covered with resin layers in a resin layer covering step shown in FIG. 3;

FIG. 8 is a sectional view of the tubular member in which the tubular member shown in FIG. 6 is covered with the resin layer in the resin layer covering step shown in FIG. 3;

FIG. 9 is a schematic perspective view for illustrating a joining step shown in FIG. 3;

FIG. 10 is a partial sectional view of the dome member and the tubular member before the joining step shown in FIG. 9;

FIG. 11 is a schematic sectional view of a liner and a reinforcement layer after the joining step shown in FIG. 10;

FIG. 12 is a partial sectional view for illustrating a forming method of seal layers on the liner after the joining step shown in FIG. 10;

FIG. 13 is a partial sectional view of the dome member and the tubular member according to a modified example of the joining step shown in FIG. 10;

FIG. 14 is a partial sectional view of the dome member and the tubular member according to a modified example before the joining step shown in FIG. 10;

FIG. 15 is a partial sectional view of the liner and the first reinforcement layer according to a modified example after the joining step shown in FIG. 10;

FIG. 16A is a partial sectional view for illustrating a forming method of a liner in a manufacturing method of a high-pressure tank of the related art; and

FIG. 16B is a partial sectional view for illustrating a forming method of the liner in the manufacturing method of the high-pressure tank of the related art.

### DETAILED DESCRIPTION OF EMBODIMENTS

Hereinafter, a manufacturing method of a high-pressure tank 1 according to an embodiment of the disclosure will be described with reference to the drawings. Before describing the manufacturing method, a configuration of the high-pressure tank 1 will be briefly described. Hereinafter, the high-pressure tank 1 will be described as a tank that is charged with high-pressure hydrogen gas and is mounted on a fuel cell vehicle. However, the high-pressure tank 1 can also be applied to other uses. The gas that can be charged in the high-pressure tank 1 is not limited to high-pressure hydrogen gas. Various compressed gases such as compressed natural gas (CNG), various liquefied gases such as liquefied natural gas (LNG) and liquefied petroleum gas (LPG), and other gases may be charged in the high-pressure tank 1.

1. High-pressure Tank 1

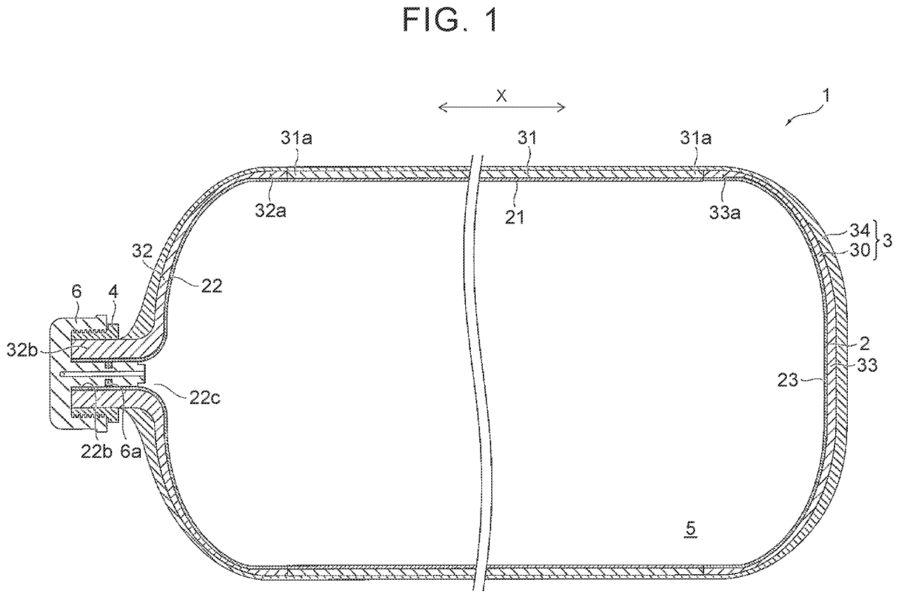

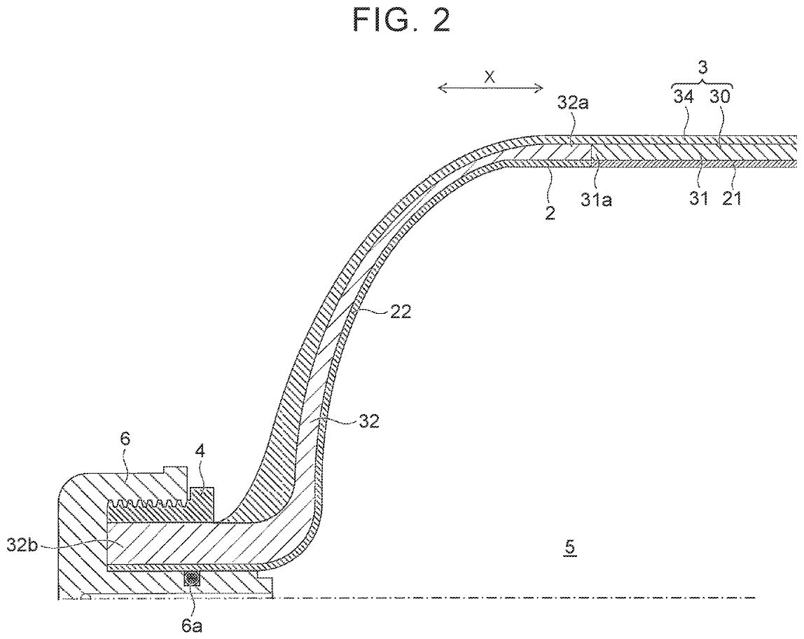

As shown in FIGS. 1 and 2, the high-pressure tank 1 is a high-pressure gas storage container having a substantially cylindrical shape, and having rounded ends in a dome shape. The high-pressure tank 1 includes a liner 2 having a gas barrier property, and a reinforcement portion 3 that is made of fiber reinforced resin and that covers an outer surface of the liner 2. The reinforcement portion 3 includes a first reinforcement layer 30 covering the outer surface of the liner 2, and a second reinforcement layer 34 covering an outer surface of the first reinforcement layer 30. An opening is provided at one end of the high-pressure tank 1, and a neck 4 is attached around the opening. The first reinforcement layer 30 corresponds to a “reinforcement layer” in the disclosure.

An accommodation space 5 for accommodating high-pressure hydrogen gas is defined in the liner 2. The liner 2 is a resin layer provided on an inner surface of the first reinforcement layer 30, and is formed by joining resin layers 21A to 23A that will be described later. The liner 2 includes a tubular body portion 21 and dome-shaped side end portions 22, 23 provided on respective sides of the body portion 21. In the embodiment, the body portion 21 extends along an axial direction X of the high-pressure tank 1 with a predetermined length and has a cylindrical shape. The side end portions 22, 23 are provided continuous to respective sides of the body portion 21 and have a dome shape. The diameters of the side end portions 22, 23 are reduced as a distance from the body portion 21 increases, and a tubular portion 22b is provided at the smallest diameter portion of one of the side end portions (side end portion 22). A through hole 22c is provided in the tubular portion 22b.

The resin constituting the liner 2 is preferably a resin having good performance of retaining the charged gas in the accommodation space 5, that is, good gas barrier property. Examples of such a resin include a thermoplastic resin and a thermosetting resin listed as resin materials described later.

The neck 4 is made by processing a metal material such as aluminum or an aluminum alloy into a predetermined shape. A valve 6 for charging and discharging hydrogen gas in and from the accommodation space 5 is attached to the neck 4. The valve 6 is provided with a seal member 6a that is in contact with an inner surface of the liner 2 at a protruding portion 32b of the dome member 32 and seals the accommodation space 5 of the high-pressure tank 1.

The reinforcement portion 3 has a function to improve mechanical strength of the high-pressure tank 1, such as rigidity and pressure resistance, by reinforcing the liner 2, and is made of a fiber reinforced resin in which reinforcing fibers (continuous fibers) are impregnated with resin. In the embodiment, as described above, the reinforcement portion 3 includes the first reinforcement layer 30 covering the outer surface of the liner 2 and the second reinforcement layer 34 coverings the outer surface of the first reinforcement layer 30. The first reinforcement layer 30 is integrally formed of a tubular member 31 that will be described later and dome members 32, 33 joined to respective sides of the tubular member 31.

The first reinforcement layer 30 is formed by laminating a plurality of fiber reinforced resin layers in which the reinforcing fibers are impregnated with resin. The reinforcing fibers of the tubular member 31 are circumferentially oriented at an angle substantially orthogonal to the axial direction X of the tubular member 31, in other words, the reinforcing fibers of the tubular member 31 are oriented in a circumferential direction of the tubular member 31. The reinforcing fibers of the dome members 32, 33 are not oriented in the circumferential direction of the tubular member 31, and extend from the vicinity of apexes of the dome members 32, 33 toward peripheral edge portions 32a, 33a in various directions intersecting the circumferential direction.

In the embodiment, the reinforcing fibers of the tubular member 31 and the reinforcing fibers of the dome members 32, 33 are not continuous (not connected). This is because, as will be described later, after the tubular member 31 and the two dome members 32, 33 are separately formed, the two dome members 32, 33 are attached to respective ends of the tubular member 31.

The second reinforcement layer 34 is formed by laminating a plurality of the fiber reinforced resin layers in which the reinforcing fibers are impregnated with resin. The second reinforcement layer 34 is formed so as to cover the outer surface of the first reinforcement layer 30. That is, the second reinforcement layer 34 is a layer that covers an outer surface of the tubular member 31 and outer surfaces of the dome members 32, 33. Specifically, the second reinforcement layer 34 is a layer made of a fiber reinforced resin in which fibers are oriented over the two dome members 32, 33. The reinforcing fibers of the second reinforcement layer 34 are oriented so as to be inclined with respect to the axial direction X of the tubular member 31 by helically winding a fiber bundle impregnated with resin. The dome members 32, 33 can be restrained to the tubular member 31 by the reinforcing fibers.

2. Manufacturing Method of High Pressure Tank 1

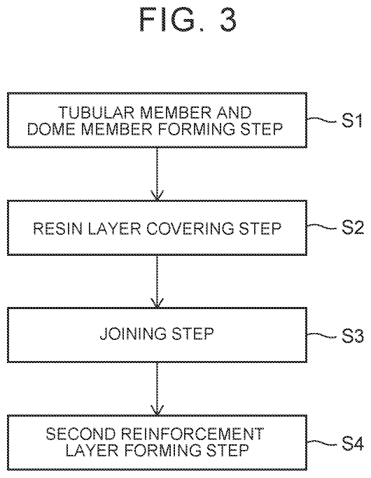

Next, the manufacturing method of the high-pressure tank 1 according to the embodiment of the disclosure will be described. FIG. 3 is a flow chart illustrating a procedure of the manufacturing method of the high-pressure tank 1. As shown in FIG. 3, the manufacturing method of the high-pressure tank 1 includes a tubular member and dome member forming step S1, a resin layer covering step S2, a joining step S3, and a second reinforcement layer forming step S4. Note that, the tubular member and dome member forming step S1 and the resin layer covering step S2 may be combined into one step, and the tubular member 31 and the dome members 32, 33 may be separately prepared.

2-1. Tubular Member and Dome Member Forming Step S1

First, the tubular member and dome member forming step S1 is performed. Formation of the tubular member 31 and formation of the dome members 32, 33 are performed independently of each other. Therefore, formation of the tubular member 31 and formation of the dome members 32, 33 may be performed in parallel, or either of the formations may be performed first. First, a forming method of the dome members 32, 33 will be described below.

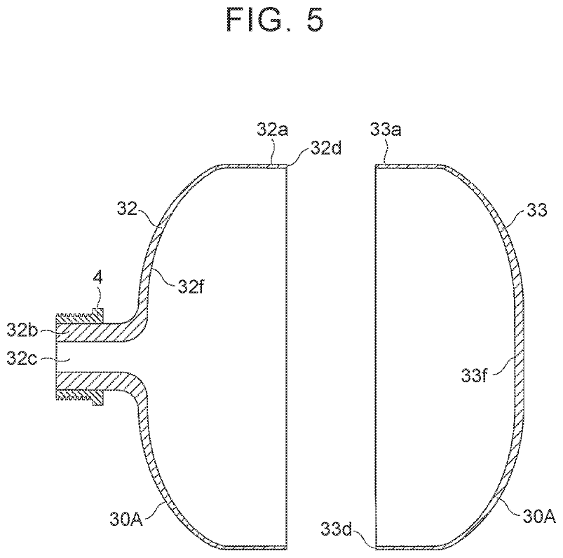

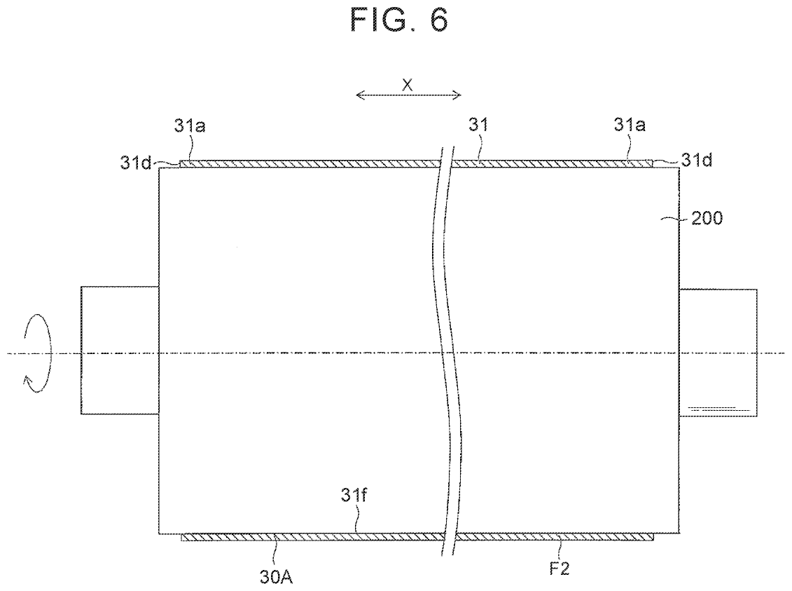

The tubular member 31 and the two dome members 32, 33 shown in FIGS. 5 and 6 are a plurality of divided bodies 30A. The divided bodies 30A have shapes in which the first reinforcement layer 30 is divided into three portions so as to include contact surfaces 31f to 33f in contact with the outer surface of the liner 2. Therefore, the tubular member 31 and the two dome members 32, 33, which are the divided bodies 30A of the first reinforcement layer 30, are made of a fiber reinforced resin.

In the embodiment, the tubular member 31 and the two dome members 32, 33 are exemplified as the divided bodies 30A having the shapes in which the first reinforcement layer 30 is divided into three parts. However, as will be described later, the number of divided bodies 30A and a position at which the first reinforcement layer 30 is divided are not particularly limited, as long as the liner 2 and the first reinforcement layer 30 can be formed by joining the divided bodies and joining the resin layers.

Forming Method of Dome Members 32, 33

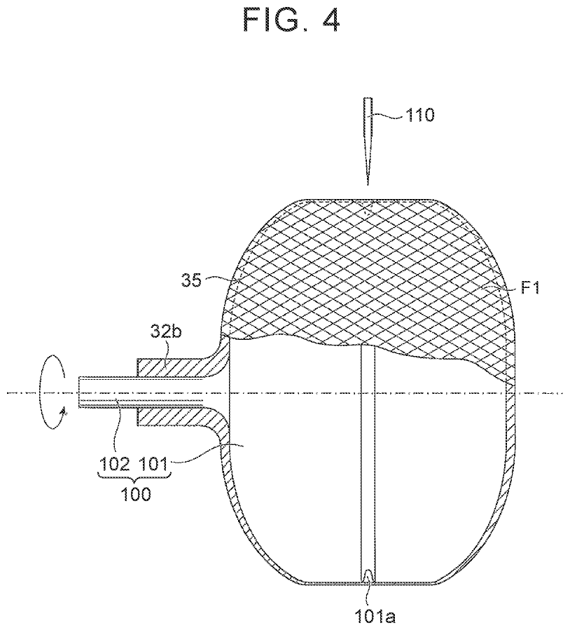

In the forming method of the dome members 32, 33 shown in FIG. 5, a fiber bundle F1 impregnated with resin is wound around an outer surface of a mandrel 100 by, for example, a filament winding process (FW process), as shown in FIG. 4. Specifically, the mandrel 100 includes a main body portion 101 and a shaft portion 102 extending outward from one end of the main body portion 101.

The main body portion 101 has a circular shape when viewed from an axial direction of the shaft portion 102. A groove 101a extending around entire circumference in the circumferential direction is formed on an outer peripheral surface of the main body portion 101 at the center in the axial direction. The outer surface of the mandrel 100 has a shape in which the dome-shaped side end portions 22, 23 are joined to each other except for the body portion 21 of the liner 2, and a groove 101a is provided at a position corresponding to a seam between the joined side end portions 22, 23. The shaft portion 102 is rotatably supported by a rotating mechanism (not shown).

When forming the dome members 32, 33, first, the mandrel 100 is rotated to wind the fiber bundle F1 so as to cover the outer surface of the mandrel 100 such that a wound article 35 is formed. During this process, winding the fiber bundle F1 around the outer surface of the shaft portion 102 provides the cylindrical protruding portion 32b having a through hole 32c as shown in FIG. 5. The fiber bundle F1 is wound at an angle that intersects the axial direction of the shaft portion 102, for example, at 30 to 50 degrees. The material of the mandrel 100 is not particularly limited. However, the material is preferably a metal in order to secure enough strength to avoid deformation of the mandrel 100 when the fiber bundle F1 is wound around.

The resin impregnated in the fiber bundle F1 is not particularly limited. However, for example, a thermosetting resin may be used. As the thermosetting resin, it is preferable to use thermosetting resin such as a phenol resin, a melamine resin, a urea resin, and an epoxy resin. In this case, the fiber bundle F1 is wound around the mandrel 100 in a state where the thermosetting resin is uncured. In particular, it is preferable to use the epoxy resin from the viewpoint of mechanical strength, etc. Epoxy resin has a fluidity in an uncured state and generates a tough cross-linked structure after being thermally cured.

A thermoplastic resin may be used as the resin to be impregnated in the fiber bundle F1. As the thermoplastic resin, for example, polyetheretherketone, polyphenylene sulfide, polyacrylic acid ester, polyimide, polyamide, nylon 6, nylon 6,6, and polyethylene terephthalate may be used. In this case, the fiber bundle F1 is wound around the mandrel 100 in a state where the thermoplastic resin is heated and softened.

As the fiber constituting the fiber bundle F1, glass fiber, aramid fiber, boron fiber, and carbon fiber, for example, may be used. In particular, it is preferable to use carbon fiber from the viewpoint of light weight and mechanical strength, etc.

Next, the wound article 35 wound around the outer surface of the mandrel 100 is divided into two by using a cutter 110 (see FIG. 4). After the process above, as shown in FIG. 5, the divided wound article 35 is removed from the mandrel 100 to provide a pair of the dome members 32, 33.

Specifically, the neck 4 is attached to the outer surface of the protruding portion 32b from the state shown in FIG. 4. When the resin impregnated in the fiber bundle F1 of the wound article 35 (that is, the resin of the dome members 32, 33) is thermosetting resin, the wound article 35 is heated such that the uncured thermosetting resin turns into a completely cured state. Here, the term “completely cured state” means a state in which a polymerization reaction of the uncured thermosetting resin is completed, and the thermosetting resin is not further cured by heating. Provided, however, that as long as shape retention of the dome members 32, 33 is ensured, the wound article 35 is heated such that the uncured thermosetting resin turns into an incompletely cured state. Here, the term “incompletely cured state” means that the fluidity of the thermosetting resin is decreased so as to secure the shape retention at a later process as the polymerization reaction of the uncured thermosetting resin progresses by heating. In the following specification, the completely cured state is referred to as full curing, the incompletely cured state is referred to as pre-curing, and the states of full curing and pre-curing are collectively referred to as thermal curing. Further, when the resin impregnated in the fiber bundle F1 of the wound article 35 is a thermoplastic resin, the softened thermoplastic resin is cooled such that the resin in the fiber bundle F1 is solidified.

With the resin impregnated in the fiber bundle F1 being thermally cured or solidified as described above, a blade of the cutter 110 is inserted into the groove 101a on the mandrel 100 while rotating the mandrel 100. With the process above, the cutter 110 cuts the fiber bundle F1 such that the wound article 35 can be divided into two. The two dome members 32, 33 are formed by removing the divided winding bodies from the mandrel 100. With this process above, ring-shaped end surfaces 32d,33d for abutting are formed on the peripheral edge portions 32a, 33a of the dome members 32, 33. The cutter 110 is not particularly limited. However, for example, the cutter 110 may be a cutter having a blade on an outer peripheral surface of a rotating disk, a cutter having a blade on a side surface of a thin plate, or a laser cutter that cuts the fiber bundle F1 using a laser light.

The resin impregnated in the fiber bundle F1 is cut by the cutter 110 in a state where the resin is thermally cured or solidified. Therefore, deformation of the fiber bundle F1 during cutting is suppressed, and at the same time, deformation of the two dome members 32, 33 when being removed from the mandrel 100 can also be suppressed.

Further, in the embodiment, the example in which the resin of the fiber bundle F1 is cut by the cutter 110 in a state where the resin is thermally cured or solidified has been described. However, the resin of the fiber bundle F1 may be cut by the cutter 110 without being thermally cured or solidified. In this case, the fiber bundle F1 may be thermally cured or solidified after being cut by the cutter 110.

In the embodiment, the example in which the fiber bundle F1 impregnated with resin is wound around the outer surface of the mandrel 100 has been described. However, the fiber bundle F1 not impregnated with resin may be wound around the outer surface of the mandrel 100 to form the wound article and the wound article may be impregnated with resin after that.

Further, in the embodiment, the example in which the neck 4 is attached to the outer surface of the protruding portion 32b after winding the fiber bundle F1 on the outer surface of the mandrel 100 has been described. However, the neck may be attached in advance to a connection portion between the main body portion 101 and the shaft portion 102 of the mandrel 100, and the fiber bundle F1 may be wound around a part of the neck along with the outer surface of the mandrel 100 in that state. In this case, the part of the neck is covered and restrained by the fiber bundle F1. Therefore, the neck can be firmly fixed by the fiber bundle F1.

Forming Method of Tubular Member 31

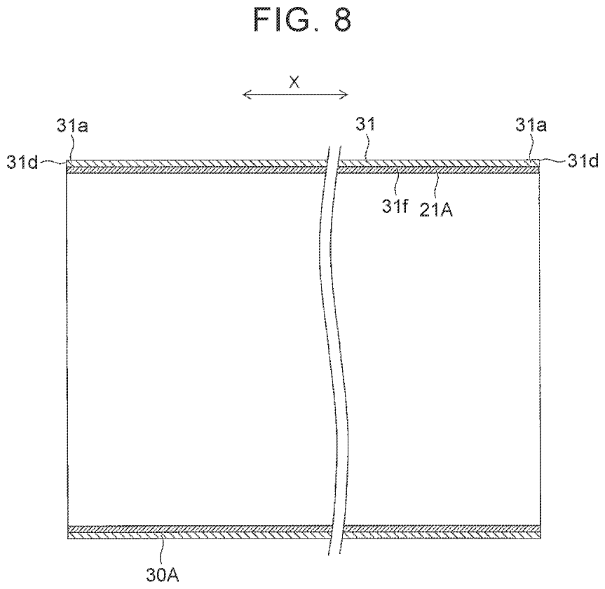

In the forming method of the tubular member 31 shown in FIG. 8, for example, the tubular member 31 that is one of the divided bodies 30A is formed by winding a fiber sheet F2 around the outer surface of a columnar mandrel 200, as shown in FIG. 6. An outer diameter of the mandrel 200 corresponds to an inner diameter of the tubular member 31, and also corresponds to a diameter of an inner periphery at the outermost position of the peripheral edge portions 32a, 33a of the dome members 32, 33. The material of the mandrel 200 is not particularly limited. However, the material is preferably a metal in order to secure enough strength to avoid deformation of the mandrel 200 when the fiber sheet F2 is attached.

When forming the tubular member 31, the fiber sheet F2 that is rolled out from a fiber sheet roll is wound around the mandrel 200 a plurality of times while rotating the mandrel 200 in a circumferential direction by a rotation mechanism (not shown). The fiber sheet F2 is a sheet in which reinforcing fibers aligned in one direction are impregnated with resin. The fiber sheet F2 is wound around the mandrel 200 such that the reinforcing fibers are oriented in the circumferential direction of the mandrel 200. With the process above, the tubular member 31 in which the reinforcing fibers are oriented in the circumferential direction is formed.

As the fiber sheet F2, for example, a so-called uni-directional (UD) sheet is used. The UD sheet is a sheet in which a plurality of fiber bundles is aligned in one direction and is woven with a restraint thread. However, a fiber sheet in which a plurality of fiber bundles aligned in a single direction and another plurality of fiber bundles that intersects with, for example, is orthogonal to, the plurality of fiber bundle are woven may be used.

The reinforcing fibers of the fiber sheet F2 may be the same material as the material exemplified in the fiber bundle F1. The resin impregnated in the reinforcing fiber may be the same resin as the material exemplified in the fiber bundle F1.

When the resin of the fiber sheet F2 is a thermosetting resin, the fiber sheet F2 may be thermally cured under pre-curing conditions or full curing conditions (heating temperature and heating time) in a state where the fiber sheet F2 is wound around the mandrel 200, as in the case of the fiber bundle F1. Further, when the resin of the fiber sheet F2 is a thermoplastic resin, the fiber sheet F2 may be solidified by cooling in a state where the fiber sheet F2 is wound around the mandrel 200, as in the case of the fiber bundle F1. With the process above, an end surface 31d for abutting is formed on each of the peripheral edge portions 31a of the tubular member 31.

After the resin is thermally cured or solidified, the tubular member 31 is removed from the mandrel 200. The shape retention of the tubular member 31 is enhanced by thermal curing or solidification of the resin. Therefore, the tubular member 31 can be easily removed from the mandrel 200, and deformation of the tubular member 31 when the tubular member 31 is removed from the mandrel 200 can be suppressed.

In the embodiment, the example in which the fiber sheet F2 is wound around the outer surface of the mandrel 200 to form the tubular member 31 has been described. However, the tubular member 31 may be formed by hoop winding of a fiber bundle impregnated with resin using the FW process on the outer surface of the mandrel 200.

Alternatively, as another method, the tubular member 31 may be formed by a so-called centrifugal winding (CW) process in which a fiber sheet is attached to an inner surface of the rotating mandrel 200.

2-2. Resin Layer Covering Step S2

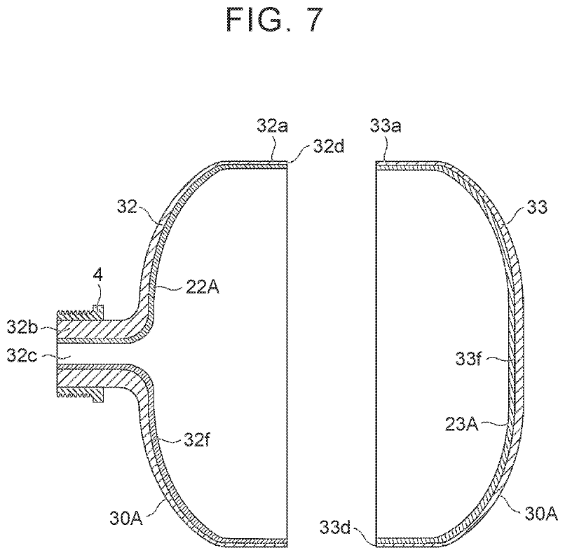

In this step, inner surfaces of the tubular member 31 and the two dome members 32, 33 that are formed in the tubular member and dome member forming step S1 are covered with the resin layers 21A to 23A. The inner surfaces above are the contact surfaces 31f to 33f in contact with the outer surface of the liner 2, and are surfaces located on an inner side of the high-pressure tank 1. Specifically, as shown in FIG. 7, the resin layers 22A, 23A covering the contact surfaces 32f, 33f of the dome members 32, 33 correspond to the side end portions 22, 23 of the liner 2 shown in FIG. 1. As shown in FIG. 8, the resin layer 21A covering the contact surface 31f of the tubular member 31 corresponds to the body portion 21 of the liner 2 shown in FIG. 1.

The resin layers 21A to 23A may be formed by applying a liquid or softened resin material, or, for example, attaching a sheet made of the resin material, to the contact surfaces 31f to 33f As described above, the resin material forming the resin layers 21A to 23A is preferably a resin having a good gas barrier property. Examples of such a resin include a thermoplastic resin and a thermosetting resin. Examples of the thermoplastic resin include polypropylene-based resin, nylon-based resin (for example, 6-nylon resin or 6,6-nylon resin), polycarbonate-based resin, acrylic-based resin, acrylonitrile butadiene styrene (ABS)-based resin, polyamide-based resin, and polyethylene-based resin, an ethylene-vinyl alcohol copolymer resin (EVOH), and a polyester resin (for example, polyethylene terephthalate). Examples of the thermosetting resin include an epoxy resin, a modified epoxy resin typified by a vinyl ester resin, a phenol resin, a melamine resin, a urea resin, an unsaturated polyester resin, an alkyd resin, a polyurethane resin, and a thermosetting polyimide resin.

In addition to the above, a two-component mixed type thermosetting resin such as an epoxy resin may be applied to the contact surfaces 31f to 33f and dried to form the respective resin layers 21A to 23A. In addition to the above, the resin layers 21A to 23A made of a thermoplastic resin such as nylon 6 may be formed by applying a resin containing a thermoplastic resin monomer, such as ϵ-caprolactam, and a catalyst to the contact surfaces 31f to 33f and heating the applied resin at a temperature equal to or higher than the temperature at which the polymerization reaction of the thermoplastic resin monomer starts.

When the resin material of the resin layers 21A to 23A is thermosetting resin, the thermosetting resin may be uncured, or may be pre-cured such that the thermosetting resin turns into an incompletely cured state. Further, the thermosetting resin may be fully cured by heating such that the thermosetting resin turns into a completely cured state. When the resin material of the resin layers 21A to 23A is thermoplastic resin, the thermoplastic resin is in a solidified state.

In the embodiment, the tubular member and dome member forming step S1 and the resin layer covering step S2 are performed separately from each other. However, for example, the tubular member and dome member forming step S1 and the resin layer covering step S2 may be performed simultaneously. Specifically, the dome members 32, 33 may be formed by forming the resin layer on the surface of the mandrel 100 shown in FIG. 4 using the method described above, forming a wound article on the resin layer, and then cutting the wound article. Similarly, the tubular member 31 may be formed on the resin layer after the resin layer is formed on the surface of the mandrel 200 shown in FIG. 6 using the method described above.

2-3. Joining Step S3

Next, the divided bodies 30A are joined to each other, and the resin layers 21A to 23A covering the divided bodies 30A are joined to each other as well. With the process above, the first reinforcement layer 30 having the divided bodies 30A and the liner 2 having the resin layers 21A to 23A covering the divided bodies 30A are formed. When joining the divided bodies 30A and joining the resin layers 21A to 23A, the divided bodies 30A are joined to each other and the resin layers 21A to 23A covering the respective divided bodies 30A are joined to each other by causing the end surfaces 31d to 33d of the divided bodies 30A to abut each other together with the resin layers 21A to 23A.

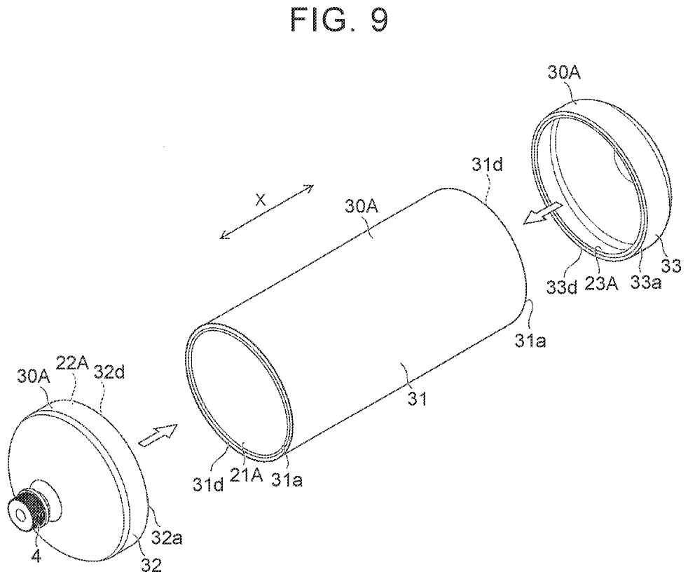

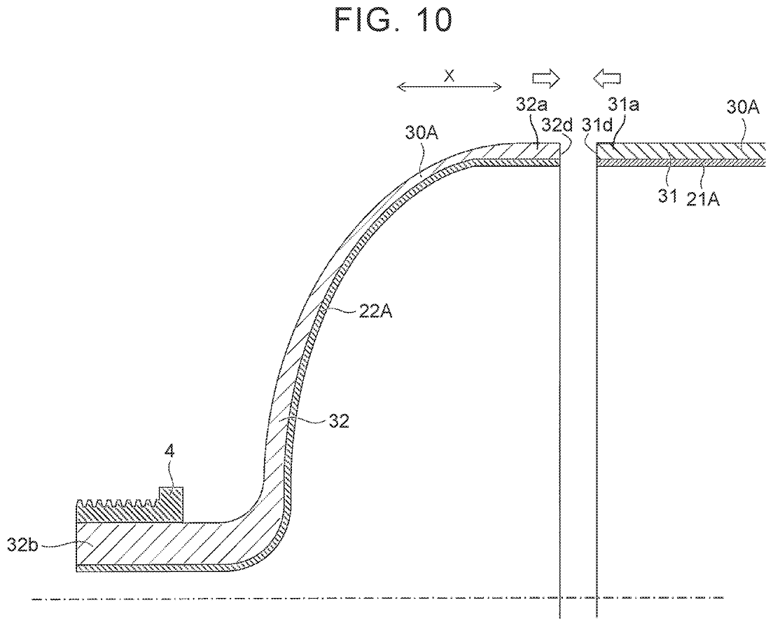

In the embodiment, the divided bodies 30A are composed of the tubular member 31 and the two dome members 32, 33. Therefore, as shown in FIGS. 9 and 10, the peripheral edge portions 31a on respective ends of the tubular member 31 and the peripheral edge portions 32a, 33a of the dome members 32, 33 are respectively joined to each other. Further, the resin layer 21A covering the tubular member 31 and the resin layers 22A, 23A covering the dome members 32, 33 are joined to each other.

During the joining process above, the tubular member 31 and the dome members 32, 33 are joined to each other and the resin layer 21A and the resin layers 22A, 23A are joined to each other by causing the end surfaces 31d of the peripheral edge portions 31a of the tubular member 31 to abut the end surfaces 32d, 33d of the peripheral edge portions 32a, 33a of the dome members 32, 33, respectively.

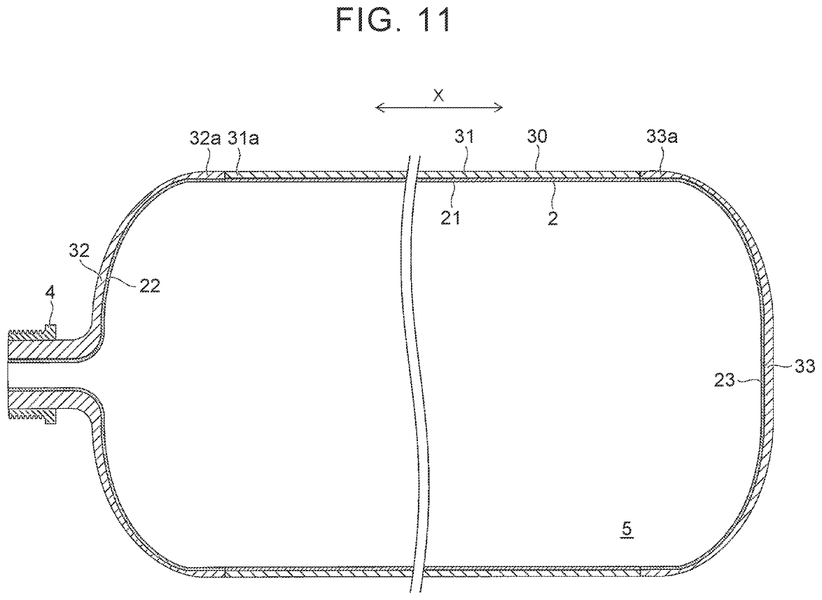

With the process above, as shown in FIG. 11, the first reinforcement layer 30 composed of the tubular member 31 and the two dome members 32, 33 and the liner 2 composed of the resin layers 21A to 23A can be formed simultaneously. The resin layer 21A serves as the tubular body portion 21 of the liner 2, and the resin layers 22A, 23A serve as the dome-shaped side end portions 22, 23 of the liner 2.

Here, the tubular member 31 and the dome members 32, 33 may be joined using, for example, an adhesive. The adhesive is preferably an adhesive of the same type as the resin impregnated in the fiber reinforced resin constituting the tubular member 31 and the dome members 32, 33. In addition to this, when the resin of the fiber reinforced resin constituting the tubular member 31 and the dome members 32, 33 is thermosetting resin, the tubular member 31 and the dome members 32, 33 are joined by causing the tubular member 31 and the dome members 32, 33 to abut each other in a state where the thermosetting resin is pre-cured and then fully curing the thermosetting resin by heating, as described above.

When the resin of the fiber reinforced resin constituting the tubular member 31 and the dome members 32, 33 is thermoplastic resin, the end surfaces 31d of the peripheral edge portions 31a of the tubular member 31 and the end surfaces 32d, 33d of the peripheral edge portions of 32a, 33a of the dome members 32, 33 may be heated and then caused to abut each other in a state where the thermoplastic resin is molten so as to be thermally bonded (joined).

The resin layer 21A covering the tubular member 31 and the resin layers 22A, 23A covering the dome members 32, 33 may be joined using the adhesive described above. The adhesive is preferably an adhesive of the same type as the resin impregnated in the fiber reinforced resin constituting the tubular member 31 and the dome members 32, 33. However, for example, the adhesive may be made of the resin of the same type as the resin of the resin layers 21A to 23A. In addition, when the resin of the resin layers 21A to 23A is thermosetting resin, the resin layers 21A to 23A may be joined to each other by causing the resin layers 21A to 23A to abut each other in a state where the thermosetting resin is uncured or pre-cured, and then fully curing the thermosetting resin by heating. When the resin of the resin layers 21A to 23A is thermoplastic resin, end portions of the resin layers 21A to 23A may be heated and abutted in a state where the thermoplastic resin is molten so as to be thermally bonded (joined).

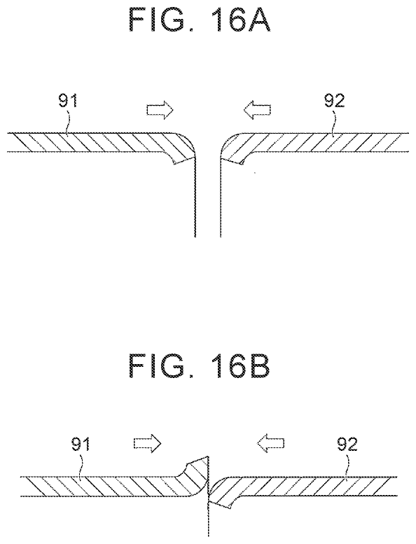

Here, a forming method of a liner in a manufacturing method of a high-pressure tank of the related art will be described with reference to FIGS. 16A and 16B. In the manufacturing method of a high-pressure tank of the related art, members 91, 92 made of thermoplastic resin or thermosetting resin are joined to each other to form the liner. In this case, as shown in FIG. 16A, when the members 91, 92 are easily deformed (have low rigidity), end portions of the members 91, 92 hang down due to their own weight. This phenomenon becomes remarkable when a thickness of the liner becomes thin. When the end portions of the members 91, 92 hang down, alignment between the members 91, 92 becomes difficult. Further, as shown in FIG. 16B, when the members 91, 92 constituting the liner are abutted and joined, the end portions of the members 91, 92 are easily deformed due to an action caused by a pressing load generated during abutting.

On the other hand, in the embodiment, when the resin layers 21A to 23A constituting the liner 2 are joined to each other, the resin layers 21A to 23A are supported by the tubular member 31 and the dome members 32, 33 corresponding to the divided bodies 30A. With this configuration, the resin layers 21A to 23A are less likely to be deformed by their own weight. Therefore, the resin layers 21A to 23A can be easily aligned with each other. Consequently, the liner 2 having a stable shape can be easily formed together with the first reinforcement layer 30.

2-4. Second Reinforcement Layer Forming Step S4

In the second reinforcement layer forming step S4, as shown in FIG. 1, the second reinforcement layer 34 made of the fiber reinforced resin is formed so as to cover the outer surface of the first reinforcement layer 30. With this configuration, the reinforcement portion 3 including the first reinforcement layer 30 and the second reinforcement layer 34 can be formed.

When forming the second reinforcement layer 34, the fiber bundle impregnated with resin is wound around the surface of the first reinforcement layer 30 in a layered manner by helical winding using the FW process. The helical winding is a winding method by which the fiber bundle is wound over the dome members 32, 33 diagonally (in a range of 10° or more and 60° or less) with respect to the axial direction X of the tubular member 31. The number of layers of the wound fiber bundles is not particularly limited as long as the strength of the second reinforcement layer 34 is ensured. However, for example, the number of layers of the wound fiber bundle is about 2 to 10.

The reinforcing fiber of the fiber bundle may be the same material as the material exemplified in the fiber bundle Fl. The resin impregnated in the reinforcing fiber may be the same resin as the resin exemplified in the fiber bundle F1.

After winding of the fiber bundle around the outer surface of the tubular member 31 is completed, the second reinforcement layer 34 is fully cured when the resin impregnated in the fiber bundle is a thermosetting resin. During this process, when the resin of the first reinforcement layer 30 and the liner 2 is thermosetting resin and not completely cured, the resin is fully cured as well. When the resin impregnated in the fiber bundle is thermoplastic resin, the second reinforcement layer 34 is cooled and solidified by leaving the resin to cool or by forced cooling. After forming the second reinforcement layer 34 as described above, the high-pressure tank 1 is completed by attaching the valve 6 to the neck 4 as shown in FIG. 1.

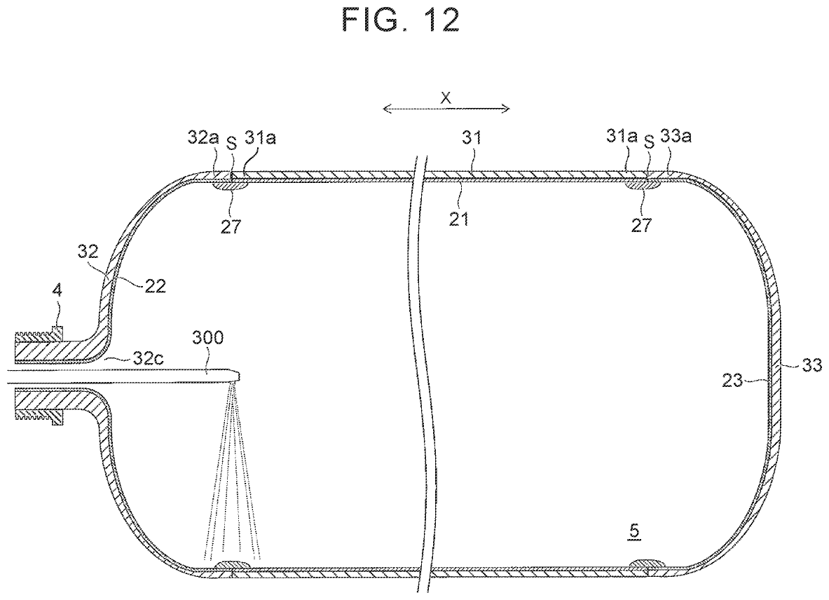

Here, as in a modified example shown in FIG. 12, after the joining step S3, seal layers 27 may be provided on seams S between the resin layer 21A covering the tubular member 31 and the resin layers 22A, 23A covering the dome members 32, 33 so as to cover the seams S.

Specifically, the seal layers 27 are formed on the seams S by inserting a nozzle 300 through the through hole 22c (32c), and applying the resin material exemplified with the resin layers 21A to 23A described above over the seams S from the nozzle 300 while rotating the liner 2 around an axis. The resin to be applied is uncured thermosetting resin or molten thermoplastic resin as described above. The seal layers 27 can be formed by fully curing or solidifying the resin material applied over the seams S. When the resin to be applied is thermoplastic resin monomer and a catalyst for polymerizing the monomer, the seal layers 27 can be formed by heating the resin at a temperature equal to or higher than a starting temperature of the polymerization reaction.

In the embodiment, the seal layers 27 are partially formed to cover the seams S. However, for example, the seal layer 27 may be formed so as to cover the entire inner surface of the liner 2. As described above, the seal layers 27 are formed on the seams S.

Therefore, airtightness of the liner 2 can be improved.

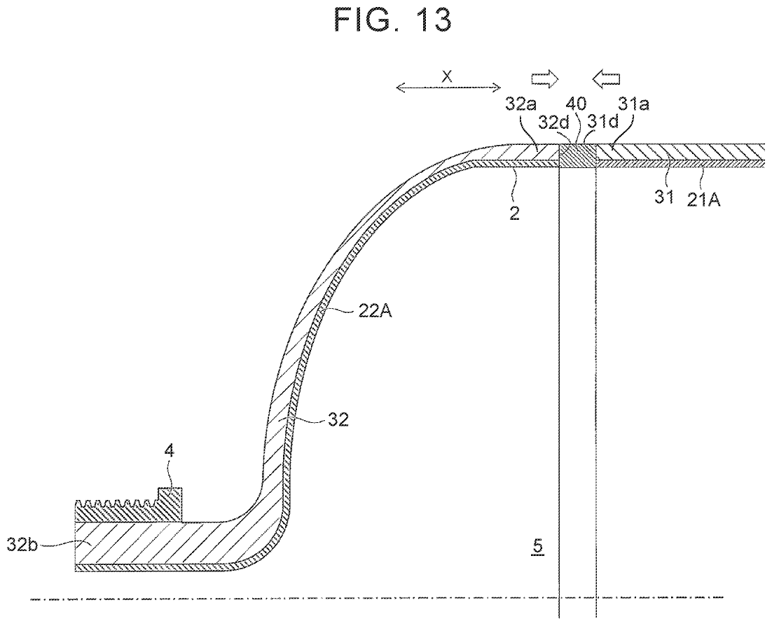

Further, as shown in FIG. 13, the end surfaces 31d of the peripheral edge portions 31a of the tubular member 31 and the end surfaces 32d, 33d of the peripheral edge portions 32a, 33a of the dome members 32, 33 may be abutted each other via a ring-shaped joining member 40 together with the resin layers 21A to 23A. With the process above, the tubular member 31 and the dome members 32, 33 can be joined, and the resin layer 21A and the resin layers 22A, 23A can be joined. The ring-shaped joining member 40 has a shape and size corresponding to the end surfaces 31d to 33d including the resin layers 21A to 23A. Further, the joining member 40 may have a shape that fits into the peripheral edge portions 31a and the peripheral edge portions 32a, 33a.

The joining member 40 is made of resin, and is preferably made of the same resin as the fiber reinforced resin constituting the tubular member 31 and the dome members 32, 33, or is preferably made of the same resin as the resin layers 21A to 23A. When the resin of the joining member 40 is thermosetting resin, the end surfaces 31d of the tubular member 31 and the end surfaces 32d, 33d of the dome members 32, 33 are abutted each other via the ring-shaped joining member 40 in a state where the thermosetting resin of the joining member 40 is in an uncured state or in a pre-cured state, and the thermosetting resin is then fully cured.

Further, when the resin of the joining member 40 is thermoplastic resin, the end surfaces 31d of the tubular member 31 and the end surfaces 32d, 33d of the dome members 32, 33 are abutted each other via the ring-shaped joining member 40 in a state where the thermoplastic resin of the joining member 40 is molten, and then the thermoplastic resin is solidified.

In the example above, the tubular member 31 and the dome members 32, 33 are joined via the joining member 40. Therefore, direct contact between the end surfaces 31d of the tubular member 31 and the end surfaces 32d, 33d of the dome members 32, 33 can be avoided. With this configuration, generation of powder dust caused by contact between the end surfaces 31d of the tubular member 31 and the end surfaces 32d, 33d of the dome members 32, 33 can be avoided. Further, the joining member 40 is also disposed between the resin layer 21A and the resin layers 22A, 23A. Therefore, the joining member 40 can serve as a sealing material. With this configuration, the airtightness of the high-pressure gas contained in the liner 2 can be improved.

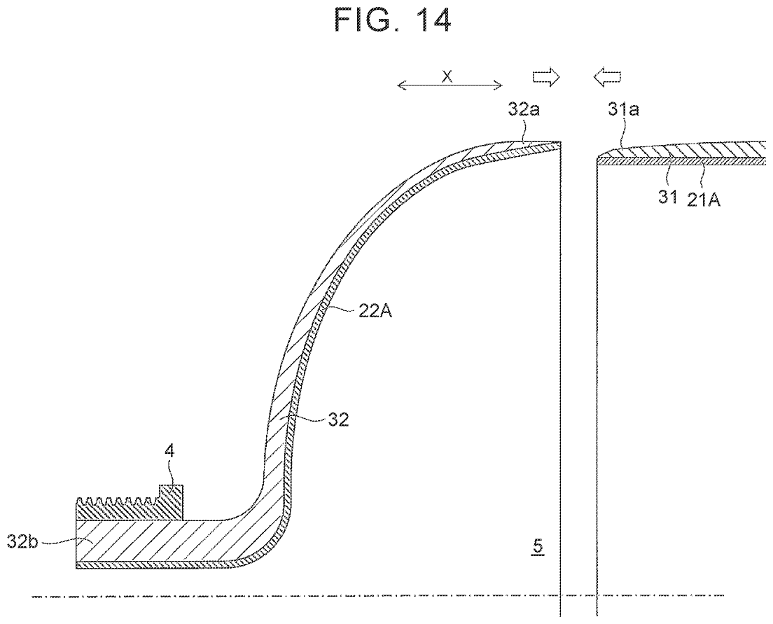

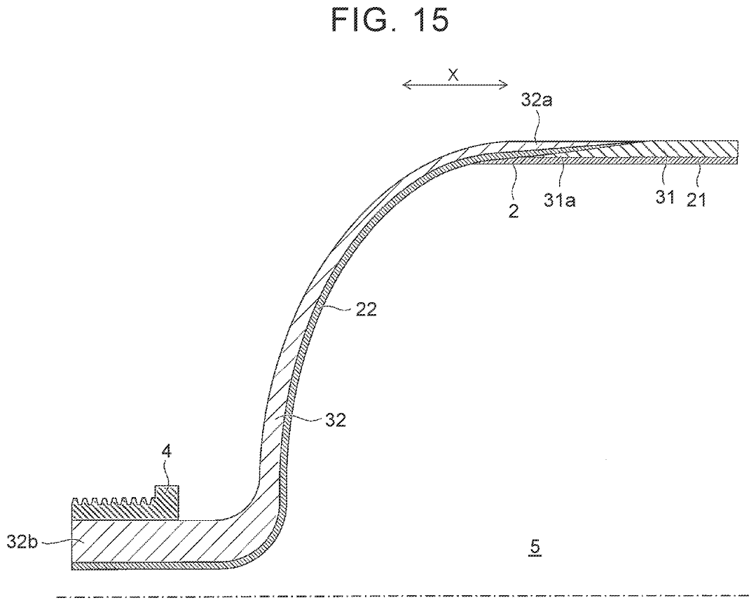

Further, the tubular member 31 and the dome members 32, 33 may be formed such that thickness of the peripheral edge portions 31a, 32a, 33a in the axial direction X is gradually reduced toward distal edges (for example, see FIG. 14). With such a shape, as shown in FIG. 15, when the peripheral edge portions 31a of the tubular member 31 and the peripheral edge portions 32a, 33a of the dome members 32, 33 are overlapped with each other, it is less likely to form a step in a connection portion between the outer surface of the tubular member 31 and the outer surfaces of the dome members 32, 33.

In order to gradually reduce the thickness of both end portions of the tubular member 31 in the axial direction X, the fiber bundle may be woven or a winding width of the fiber sheet F2 may be gradually reduced such that the thickness of the fiber bundle at an end portion of the fiber sheet F2 (shown in FIG. 6) in the axial direction X (width direction) is gradually reduced. In addition to this, the thickness may be gradually reduced by pressing both ends of the tubular member 31 in the axial direction X with a roller, etc. The thickness of the peripheral edge portions 32a, 33a of the dome members 32, 33 may also be reduced from the thickness of the other portions by pressing the peripheral edge portions 32a, 33a with a roller, etc.

In the joining step S3, as shown in FIGS. 14 and 15, the peripheral edge portions 32a, 33a of the dome members 32, 33 are joined to the peripheral edge portions 31a of the tubular member 31, respectively, to form the first reinforcement layer 30 and the liner 2 at the same time.

Specifically, the peripheral edge portions 31a of the tubular member 31 and the peripheral edge portions 32a, 33a of the dome members 32, 33 are fit together, with one on the inner side and the other on the outer side. With the process above, the tubular member 31 and the dome members 32, 33 can be further firmly joined together. FIG. 15 shows that the tubular member 31 and the dome members 32, 33 are fit together with the peripheral edge portions 31a of the tubular member 31 being on the inner side and the peripheral edge portions 32a, 33a of the dome members 32, 33 being on the outer side, as one example.

When fitting, an adhesive may be applied between the tubular member 31 and the dome members 32, 33. With this configuration, detachment of the dome members 32, 33 from the tubular member 31 can be more reliably suppressed in a later process. The material of the adhesive is not particularly limited. However, for example, the adhesive is preferably a thermosetting resin, such as an epoxy resin. Further, as the adhesive, a resin having the same composition as the resin of the tubular member 31 or the dome members 32, 33 may be used.

The embodiments disclosed herein should be considered as illustrative and not restrictive in all respects. The scope of the disclosure is shown by the claims, rather than the above embodiments, and is intended to include all modifications within the meaning and the scope equivalent to those of the claims.

For example, in the above embodiment, the example in which the through hole is provided only in one of the dome members and the neck is provided only in one of the end portions of the high-pressure tank has been described. However, the disclosure is not limited to this example, and the through hole may be provided in each of the dome members, and the neck may be provided in each of the one end portion and the other end portion of the high-pressure tank.

Further, in the above embodiment, the example in which the two dome members are formed using the FW process has been described. However, the disclosure is not limited to this example. For example, a pair of dome members may be formed by applying the fiber bundle to the surface of a dome-shaped mold and pressing the fiber bundle with a roller using a tape placement process.

Further, in the above embodiment, the example in which the first reinforcement layer is composed of three members (the tubular member and the two dome members) has been described. However, the disclosure is not limited to this example. For example, the first reinforcement layer may be composed of four or more members (two or more tubular members and two dome members). In this case, after joining two or more tubular members to each other, the dome members may be joined to respective ends of the joined tubular members. Further, after joining one tubular member to each of the dome members, the tubular members with dome members joined may be joined together.

What is claimed is:

1. A manufacturing method of a high-pressure tank in which a reinforcement layer made of fiber reinforced resin is provided on an outer surface of a liner that is made of resin and is configured to contain gas, the method comprising:
forming a plurality of divided bodies made of the fiber reinforced resin and having a shape in which the reinforcement layer is divided so as to include contact surfaces in contact with the outer surface of the liner;
covering the contact surfaces of the divided bodies with respective resin layers constituting the liner; and
forming the reinforcement layer having the divided bodies and the liner having the resin layers by joining the divided bodies to each other and joining the resin layers covering the divided bodies to each other.

2. The manufacturing method according to claim 1, wherein the divided bodies are jointed to each other and the resin layers covering the divided bodies are joined to each other by causing end surfaces of the divided bodies to abut each other together with the resin layers via a joining member.

3. The manufacturing method according to claim 1, wherein:
a tubular member and two dome members that are the divided bodies covered with the resin layers are prepared and a through hole is provided on at least one of the two dome members;
the reinforcement layer and the liner are formed by joining peripheral edge portions on respective ends of the tubular member to peripheral edge portions of the dome members, and joining the resin layer covering the tubular member to the resin layers covering the dome members; and
after the reinforcement layer and the liner are formed, seal layers are formed on at least seams between the resin layer covering the tubular member and the resin layers covering the dome members by applying a resin material to the seams via the through hole such that at least the seams are covered by the seal layers.
